(19) United States
(12) Patent Application Publication
(10) Pub. No.: US 2012/0189133 A1
(43) Pub. Date: Jul. 26, 2012

(54) Headset With Configuration Switch

(75) Inventors: Juhani V. Kari, Lieto (FI); Heini Saari, Turku (FI); Petri J. Seppala, Halikko (FI); Olga Cherepenina, Salo (FI)

(73) Assignee: Nokia Corporation

(21) Appl. No.: 13/014,007

(22) Filed: Jan. 26, 2011

(51) Int. Cl. H04R 1/10

(52) U.S. Cl. 381/74

(57) ABSTRACT

An apparatus including a first section which is sized and shaped to be supportably mounted on a person's ear, a second section movably connected to the first section, and a switch. The first section includes a speaker. The second section is movable between a first home position and a second outward position relative to the first home position and the first section. The switch is configured to be automatically actuated when the second section is moved relative to the first section between the first home position and the second outward position. The switch is OFF when the first and second sections are in a first configuration with the second section in the first home position. The switch is ON when the first and second sections are in a second different configuration with the second section in the second outward position.

### BACKGROUND

1. Technical Field

The exemplary and non-limiting embodiments relate generally to a wireless headset and, more particularly, to a headset switch.

2. Brief Description of Prior Developments

Various wireless headset devices, such as BLUETOOTH headsets, are popular accessory products that are designed to improve usability of mobile phones and other similar devices.

### SUMMARY

The following summary is merely intended to be exemplary. The summary is not intended to limit the scope of the claims.

In accordance with one aspect, an apparatus is provided including a first section which is sized and shaped to be supportably mounted on a person's ear, a second section movably connected to the first section, and a switch. The first section includes a speaker. The second section is movable between a first home position and a second outward position relative to the first home position and the first section. The switch is configured to be automatically actuated when the second section is moved relative to the first section between the first home position and the second outward position. The switch is OFF when the first and second sections are in a first configuration with the second section in the first home position. The switch is ON when the first and second sections are in a second different configuration with the second section in the second outward position.

In accordance with another aspect, an apparatus is provided comprising a housing, electronics and a configuration switch. The housing includes a first section and a second section movably connected to the first section, where the first or second sections are configured to be supportably mounted on a person's ear, and where the first and second sections are configured to move relative to each other between a first configuration and a second different configuration. The electronics are in the first section and comprise a speaker, a wireless transmitter and a wireless receiver. The configuration switch is connected to the electronics where, when the first and second sections are reconfigured from the first configuration to the second different configuration, the configuration switch is adapted to turn the apparatus ON and have the electronics send a wireless signal.

In accordance with another aspect, a method is provided comprising moving a movable element relative to a first section of a wireless headset, where the first section is sized and shaped to be supportably mounted on a person's ear, where the first section comprises a speaker, and where the movable element is moved between a first home position and a second outward position relative to the first home position and the first section; and automatically actuating a switch based upon movement of the movable element between the first home position and the second outward position, where the switch is OFF when the first section and the movable element are in a first configuration with the movable element in the first home position, and where the switch is ON when the first section and the movable element are in a second different configuration with the movable element in the second outward position.

In accordance with another aspect, a method is provided comprising connecting a movable element to a first section of a wireless headset device, where the movable element is configured to move on the first section between a first home position and a second outward position relative to the first home position; and connecting a switch to the first section such that the switch is automatically actuated when the movable element is moved between the first and second positions, where the switch is OFF when the first section and the movable element are in a first configuration with the movable element in the first home position, and where the switch is ON when the first section and the movable element are in a second different configuration with the movable element in the second outward position.

### BRIEF DESCRIPTION OF THE DRAWINGS

The foregoing aspects and other features are explained in the following description, taken in connection with the accompanying drawings, wherein:

FIG. 1 is a diagram illustrating a wireless connection of an example embodiment to a device;

FIG. 2 is a front view of the apparatus shown in FIG. 1 in a first home configuration;

FIG. 3 is a front view of the apparatus shown in FIG. 2 in a second configuration;

FIG. 4 is a perspective view of the apparatus shown in FIG. 3;

FIG. 5 is a perspective view of the apparatus shown in FIG. 4 showing how a user's fingers may be used to close the apparatus;

FIG. 6 is a diagram illustrating some of the components of the apparatus shown in FIG. 2;

FIG. 7 is a diagram illustrating some steps of an example method of using the apparatus shown in FIG. 2;

FIG. 8 is a perspective view of an alternate example embodiment of the apparatus shown in FIG. 2 in a first configuration;

FIG. 9 is an end view of the apparatus shown in FIG. 8;

FIG. 10 is a perspective view of the apparatus shown in FIG. 8 in a second configuration;

FIG. 11 is an end view of the apparatus shown in FIG. 10;

FIG. 12 is an end view similar to FIG. 11 of another example embodiment;

FIG. 13 is a perspective view of an alternate example embodiment of the apparatus shown in FIG. 2 in a first configuration;

FIG. 14 is an end view of the apparatus shown in FIG. 13;

FIG. 15 is a perspective view of the apparatus shown in FIG. 13 in a second configuration;

FIG. 16 is an end view of the apparatus shown in FIG. 15;

FIG. 17 is a perspective view of an alternate example embodiment of the apparatus shown in FIG. 2 in a first configuration;

FIG. 18 is a perspective view of the apparatus shown in FIG. 17 in a second configuration;

FIG. 19 is a perspective view of an alternate example embodiment of the apparatus shown in FIG. 2 in a first configuration;

FIG. 20 is a perspective view of the apparatus shown in FIG. 19 in a second configuration;

FIG. 21 is a perspective view of an alternate example embodiment of the apparatus shown in FIG. 2 in a first configuration;

FIG. 22 is a side view of the apparatus shown in FIG. 21;

FIG. 23 is a perspective view of the apparatus shown in FIG. 21 in a second configuration;

FIG. 24 is a side view of the apparatus shown in FIG. 23;

FIG. 25 is a perspective view of an alternate example embodiment of the apparatus shown in FIG. 2 in a first configuration;

FIG. 26 is a side view of the apparatus shown in FIG. 25;

FIG. 27 is a perspective view of the apparatus shown in FIG. 25 in a second configuration;

FIG. 28 is a side view of the apparatus shown in FIG. 27;

FIG. 29 is a perspective view of an alternate example embodiment of the apparatus shown in FIG. 2 in a first configuration;

FIG. 30 is a perspective view of the apparatus shown in FIG. 29 in a second configuration;

FIG. 31 is a perspective view of an alternate example embodiment of the apparatus shown in FIG. 2 in a first configuration;

FIG. 32 is a perspective view of the apparatus shown in FIG. 31 in a second configuration;

FIG. 33 is a perspective view of an alternate example embodiment of the apparatus shown in FIG. 2 in a first configuration;

FIG. 34 is a perspective view of the apparatus shown in FIG. 33 in a second configuration;

FIG. 35 is a perspective view of an alternate example embodiment of the apparatus shown in FIG. 2 in a first configuration;

FIG. 36 is a perspective view of the apparatus shown in FIG. 35 in a second configuration;

FIG. 37 is a perspective view of an alternate example embodiment of the apparatus shown in FIG. 2 in a first configuration; and

FIG. 38 is a perspective view of the apparatus shown in FIG. 37 in a second configuration.

### DETAILED DESCRIPTION OF EMBODIMENTS

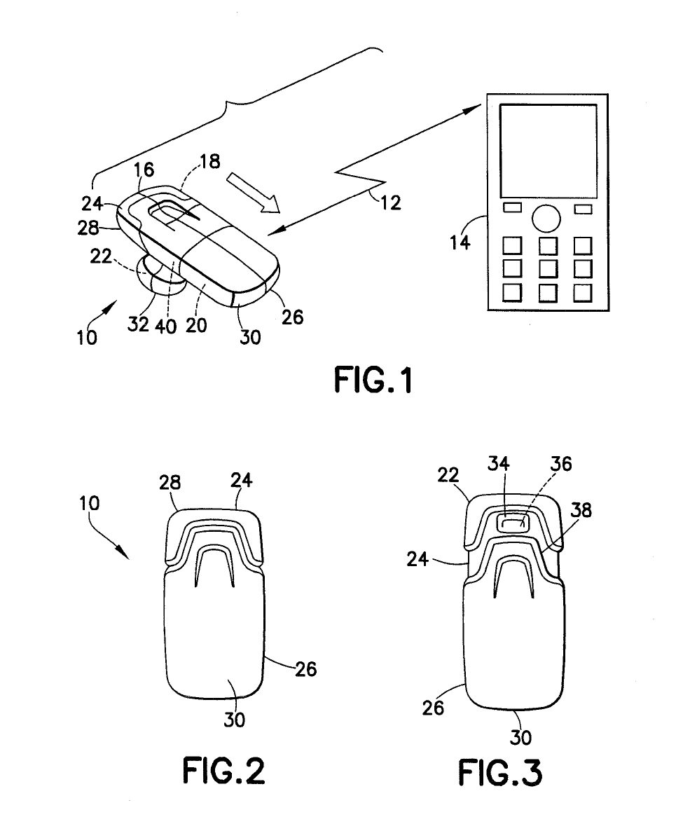

Referring to FIG. 1, there is shown a diagram illustrating an apparatus 10 incorporating features of an example embodiment, capable of a wireless link or connection 12 to a device 14. Although features will be described with reference to the example embodiments shown in the drawings, it should be understood that features can be embodied in many alternate forms of embodiments. In addition, any suitable size, shape or type of elements or materials could be used.

The device 14 is a mobile telephone in this example. The device 14 is able to provide telephone service to a mobile telephone network. The device also has a short range wireless communication function, such as BLUETOOTH for example, to establish the radio frequency link 12 with the apparatus 10. However, in an alternate embodiment any suitable device could be provided for the device 14, such as a music player, PDA, laptop computer, video camera, etc.

The apparatus 10 is a wireless headset which is adapted to be supportably mounted at a person's ear. The apparatus 10 has a housing 16, electronics or electrical components 18 in the housing, and a battery 20 in the housing. The electrical components 18 include a speaker 22, a transmitter and a receiver. The transmitter and receiver can communicate with the device 14 via the link 12. The electronics could also comprise a microphone. Thus, the apparatus 10 can be used with the device 14 for hands-free use of the device 14, such as when driving a vehicle for example.

The housing 16 comprises a first housing member 24 and a movable element 26. In this example, the electronics and battery are housed in the first housing member 24. Thus, the apparatus 10 has a first section 28 formed by the first housing member, and a second section 30 formed by the movable element 26. The first housing member 24 in this example has a portion 32 which is sized and shaped to be inserted in an ear canal of a person's ear. The speaker 22 is located in this portion 32.

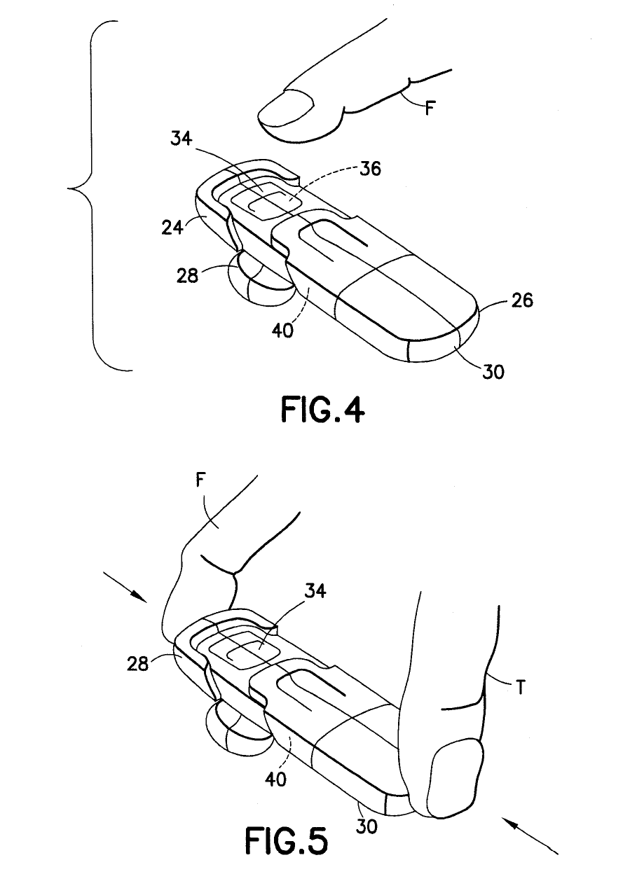

FIGS. 1 and 2 show the apparatus 10 in a first configuration. In this first configuration the movable element 26 is in a first home position relative to the first section 28. Referring also to FIGS. 3-4, the apparatus 10 is shown in a second different physical configuration. In this second configuration the movable element is located at a second outward location relative to the first home position on the first section 28. The movable element 26 is movable on the first section 28 between the first and second positions. In this example the movable connection is a slidable connection. Thus, the movable element is able to longitudinally slide between the first and second positions to provide the first and second configurations of the apparatus 10.

The first section 28 includes a send/end key or button 34. When the apparatus 10 is in the first configuration, with the movable element in the first home position shown in FIGS. 1-2, the send/end key 34 is covered by a portion of the movable element 26. When the apparatus 10 is in the second configuration, with the movable element in the second outward position shown in FIGS. 3-4, the send/end key 34 is not covered by the movable element 26. An open space 38 is created above the key 34. Thus, the send/end key 34 cannot be used in the first configuration when the movable element 26 is closed (FIGS. 1-2). However, the send/end key 34 can be used in the second configuration when the movable element 26 is open (FIGS. 3-4). A user can depress the key 34 with his or her finger F. A switch 36 is located under the key 34. When key 34 is depressed, the switch 36 is actuated. When the switch 36 is actuated, the electrical components 18 can send a signal by means of the transmitter to the device 14, such as to switch between two telephone calls (swap), or to end a telephone call (on-hook) for example.

The apparatus 10 also comprises a configuration switch 40. The configuration switch 40 is connected to the other electronics in the first section 28 and is adapted to signal when the movable element 26 is moved between the first and second configurations. In one type of alternate embodiment the switch 36 could be used as the configuration change/detection switch function rather than providing this function in the separate second switch 40.

The switch 40 is configured to be automatically actuated when the second section 30 is moved relative to the first section 28 between the first home position and the second outward position. When the apparatus 10 is in the first configuration, with the second section in the first home position (FIGS. 1-2), the switch 40 is OFF. When the first and second sections are in the second different configuration, with the second section in the second outward position (FIGS. 3-4), the switch is ON. When the switch 40 is OFF, the apparatus 10 is OFF. When the switch 40 is moved from OFF to ON, the apparatus 10 is turned ON and the apparatus may send a wireless signal to the device 14. This signal may cause the device 14 to establish the link 12, and perhaps also answer an incoming call. Thus, merely by changing the configuration of the apparatus 10, the apparatus may be powered up, establish a link with another device, and perhaps instruct the other device to answer an incoming telephone call (or perform some other type of action automatically).

Referring also to FIG. 5, in order to change the configuration of the apparatus 10 from the open configuration shown in FIGS. 3-4 to the closed position shown in FIGS. 1-2, a user can use two fingers F and T to slide the second section 30 back to its home position on the first section 28. As the second section 30 is slid, it covers the key 34 again, and actuates the switch 40 again. This may cause the apparatus 10 to power down (turn OFF) and perhaps send a signal to the device 14 to end a telephone call.

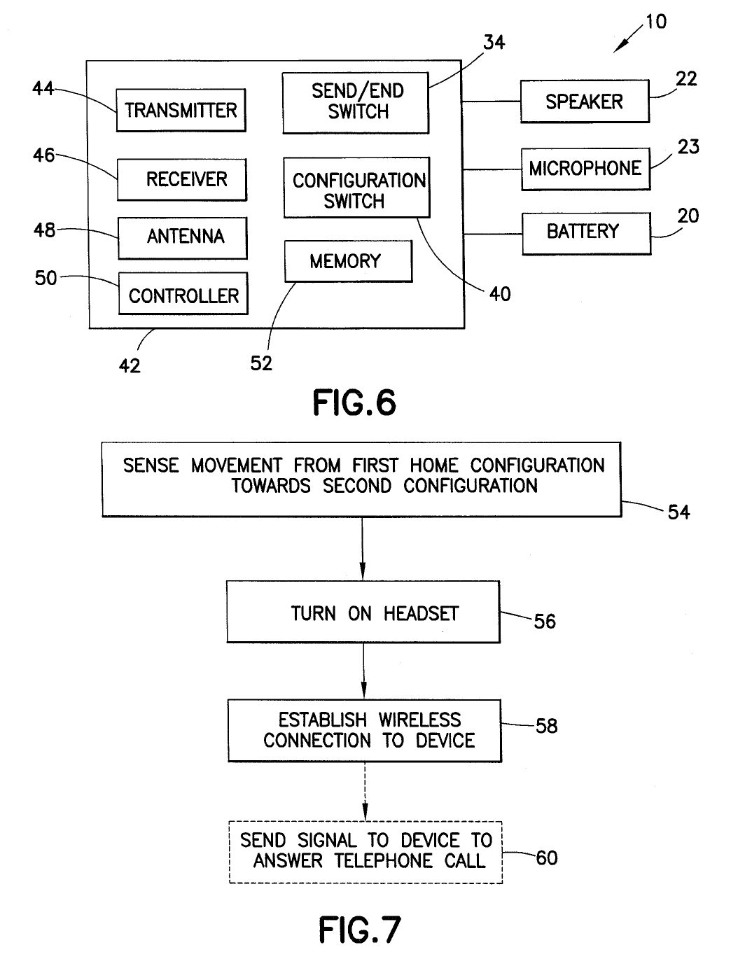

Referring also to FIG. 6, the electronics or electrical components 18 of the apparatus 10 can comprise a printed wiring board (PWB) 42 connected to the speaker 22, the microphone 23 and the battery 20. In this example, the two switches 36, 40 are on the PWB 42 as well as the transmitter 44, receiver 46, controller 50 such as a microprocessor for example, memory 52 and an antenna which could be integrally formed as part of the PWB. At least some of the electronics, such as the microphone for example, are located in the second section. Thus, besides a movable mechanical connection between the first and second sections, there is also an electrical connection between components in the first and second sections.

Referring also to FIG. 7, the switch 40 may sense movement of the body part or movable element 26 from its home position (FIGS. 1-2) towards its second position; the second configuration (FIGS. 3-4) as indicated by block 54. This causes the electronics of the apparatus 10 to power-up (turn ON) as indicated by block 56. A wireless connection 12 may be automatically established between the apparatus 10 and the device 14 as indicated by block 58. The apparatus may also send a signal to the device 14 to answer a telephone call as indicated by block 60. In an alternate embodiment the device 14 could be programmed to automatically answer a telephone call when the link 12 is established (step 58) without the need for the apparatus to send an off-hook signal (step 60).

A feature of the example described above is that the change in configuration of the apparatus is used to turn the apparatus ON and OFF. The configuration is easily detectable by the user by sight or by touch (such as if still on the person's ear). By using a relatively large body part movement of the apparatus to actuate the configuration switch 40, there is no need for the user to deal with a small ON/OFF switch (which people with big hands, or people with physical disabilities might otherwise have problems with). Thus, the example described above may be particularly useful to allow a person with a hand disability, or a hand motor control disability, the ability to use a wireless handset. The feature of using the configuration change to turn ON and OFF the handset also increases the opportunity to make the headset even smaller than currently available headsets; there being no need to provide a button with is large enough for a person's finger to turn the headset ON and OFF.

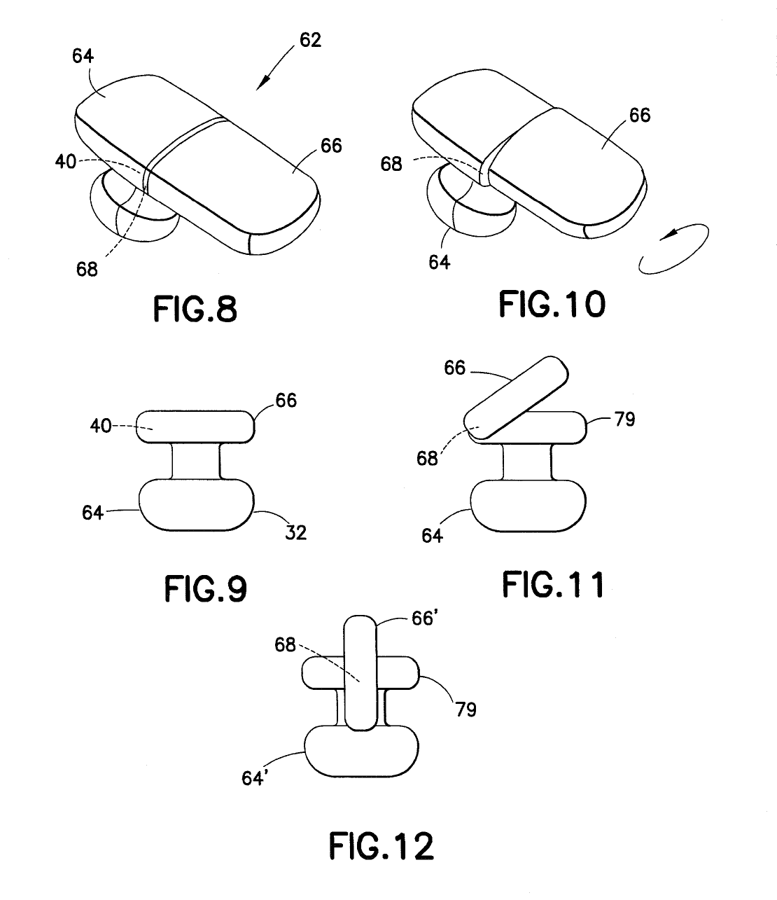

Referring also to FIGS. 8-9, an alternate embodiment is shown. In this embodiment the headset 62 has a first section 64 and a second section 66. The connection of the second section 66 to the first section 64 comprises a rotatable connection rather than a longitudinally slidable connection as in the first embodiment. The first section 64 may be substantially identical to the first section 28 except for the connection to the second section 66. However, in this embodiment the second section 66 could comprise at least some the electronics or electrical components 18 and/or the battery 20, and comprises the microphone 23. The first section 64 in this example also has a portion 32 which is sized and shaped to be inserted in an ear canal of a person's ear. The speaker 22 is located in this portion 32. The portion 32 supportably mounts the apparatus 62 on the person's ear.

FIGS. 8-9 show the apparatus 62 in its first home configuration. Referring also to FIGS. 10-11, the apparatus 62 is shown in a second different configuration. In the first configuration the second section 66 is at a first home position relative to the first section 64. The configuration switch 40 is OFF. Thus, the apparatus 62 is powered down (turned OFF).

In the second different configuration (FIGS. 10-11) the second section 66 is located at a second outward position relative to the first home position and the first section 64. Movement of the two sections 64, 66 causes the configuration switch 40 to be actuated to turn ON the apparatus 62. The rotational connection 68 of the first and second sections 64, 66 is off-center in this embodiment. FIG. 12 illustrates an alternate embodiment where the rotational connection 68′ is centered between the two sections 64′, 66′. Any suitable location of the rotation connection could be provided. Similar to the first example embodiment described above, the switch 40 may sense movement of the body part or movable element 66 from its home position (FIGS. 8-9) towards its second position such as at the second configuration (FIGS. 10-11). This causes the electronics of the apparatus 62 to power-up (turn ON). A wireless connection may be automatically established between the apparatus 62 and the device 14. The apparatus may also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 62 from its second configuration back to its first configuration, this may actuate the switch 40 again or turn the switch OFF. This may cause the apparatus 62 to power down (turn OFF) and perhaps send a signal to the device 14 to end a telephone call. Again, similar to the first example embodiment, the change in configuration of the apparatus is used to turn the apparatus 62 ON and OFF. The configuration is easily detectable by the user by sight or touch (such as if still on the person's ear). By using a relatively large apparatus housing/body part movement to actuate the configuration switch 40, there is no need for the user to deal with a small ON/OFF switch. At least some of the electronics, such as the microphone for example, are located in the second section. Thus, besides a movable mechanical connection between the first and second sections, there is also an electrical connection between components in the first and second sections, such as through the same connection 68

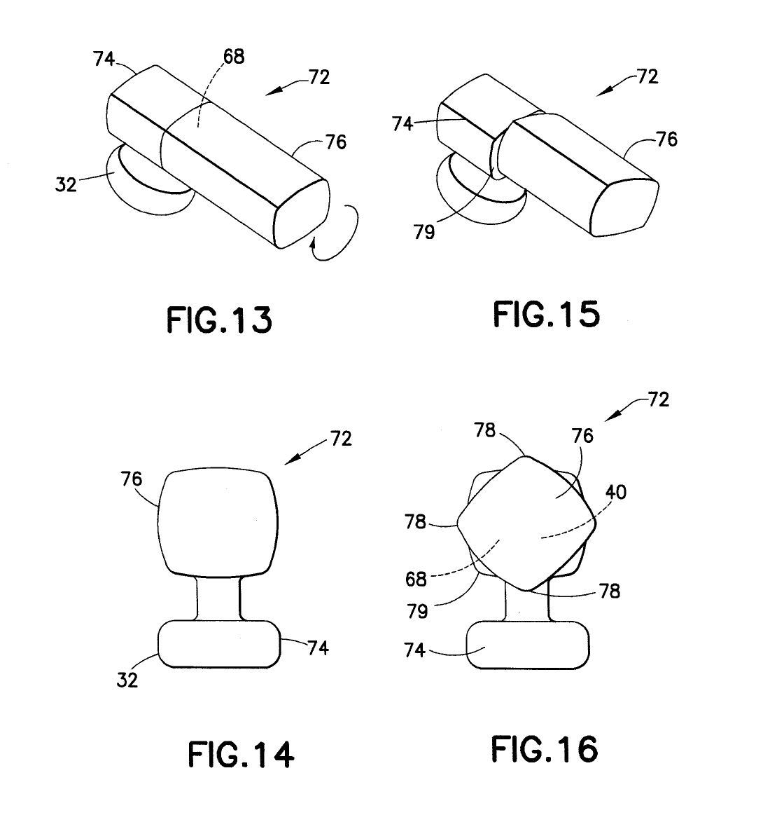

Referring also to FIGS. 13-14, another alternate embodiment is shown. In this embodiment the headset 72 has a first section 74 and a second section 76. The connection 68 of the second section 76 to the first section 74 comprises a rotatable connection rather than a longitudinally slidable connection as in the first embodiment. The first section 74 may be substantially identical to the first section 28 except for the connection to the second section 76. However, in this embodiment the second section 76 could comprise at least some the electronics 18 and the battery 20, and comprises the microphone 23. The first section 74 in this example also has a portion 32 which is sized and shaped to be inserted in an ear canal of a person's ear. The speaker 22 is located in this portion 32. The portion 32 supportably mounts the apparatus 72 on the person's ear.

FIGS. 13-14 show the apparatus 72 in its first home configuration. Referring also to FIGS. 15-16, the apparatus 72 is shown in a second different configuration. In the first configuration the second section 76 is at a first home position relative to the first section 74. The configuration switch 40 is OFF. Thus, the apparatus 72 is powered down (turned OFF). At least some of the electronics, such as the microphone for example, are located in the second section. Thus, besides a movable mechanical connection between the first and second sections, there is also an electrical connection between components in the first and second sections.

In the second different configuration (FIGS. 15-16) the second section 76 is located at a second outward position relative to the first home position and the first section 74. Portions 78 are outwardly located. Movement of the two sections 74, 76 causes the configuration switch 40 to be actuated to turn ON the apparatus 72. The rotational connection 68 of the first and second sections 74, 76 is centered on the center longitudinal axis of the second section 76 in this embodiment. However, in an alternate embodiment the second section 76 could tilt of flip outward. Similar to the first example embodiment described above, the switch 40 may sense movement of the body part or movable element 76 from its home position (FIGS. 13-14) towards its second position such as at the second configuration (FIGS. 15-16). This causes the electronics of the apparatus 72 to power-up (turn ON). A wireless connection may be automatically established between the apparatus 72 and the device 14. The apparatus may also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 72 from its second configuration back to its first configuration, this may actuate the switch 40 again or turn the switch OFF. This may cause the apparatus 72 to power down (turn OFF) and perhaps send a signal to the device 14 to end a telephone call. Again, similar to the first example embodiment, the change in configuration of the apparatus is used to turn the apparatus 72 ON and OFF. The configuration is easily detectable by the user by sight or touch (if still on the person's ear). By using a relatively large body part movement to actuate the configuration switch 40, there is no need for the user to deal with a small ON/OFF switch. With this third embodiment, similar to the second embodiment, twisting a body member of the apparatus may turn ON the apparatus and answer a call, and twisting the body member may turn OFF the apparatus. Color, or perhaps light emission, at surfaces 79 could also be used as a visual indication of the second configuration.

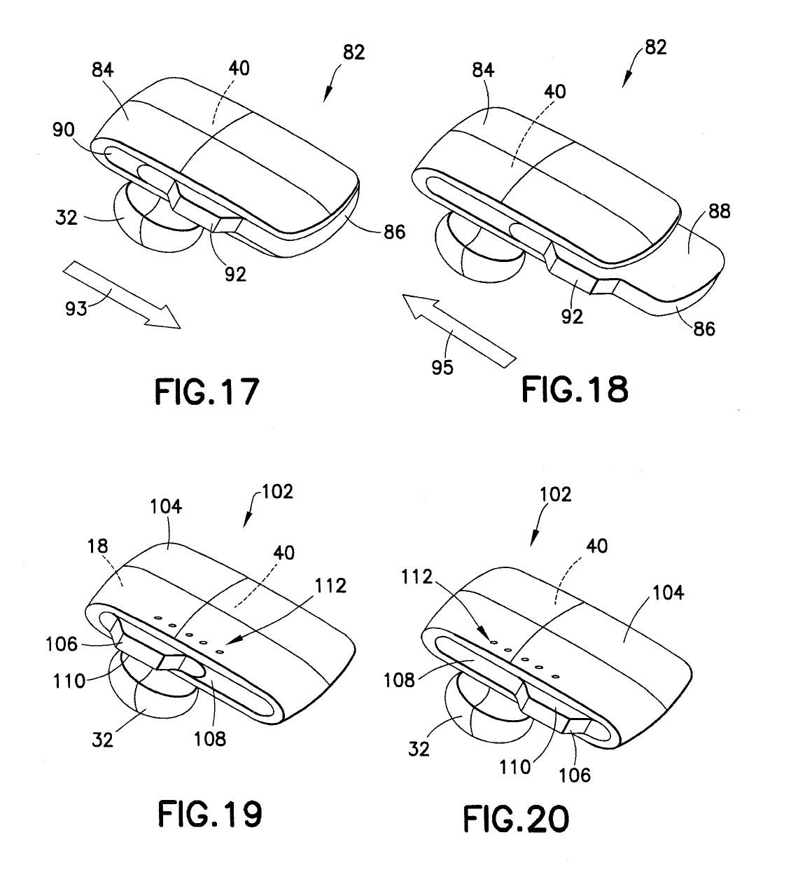

Referring also to FIGS. 17-18, another example embodiment is shown. In this embodiment the headset 82 has a first section 84 and a second section 86. The connection of the second section 86 to the first section 84 comprises a longitudinally slidable connection rather than a rotational connection. The first section 84 in this example also has a portion 32 which is sized and shaped to be inserted in an ear canal of a person's ear. The speaker 22 is located in this portion 32. The portion 32 supportably mounts the apparatus 82 on the person's ear. At least some of the electronics, such as the microphone for example, are located in the second section 86. Thus, besides a movable mechanical connection between the first and second sections, there is also an electrical connection between the first and second sections.

FIG. 17 shows the apparatus 82 in its first home configuration. In FIG. 18 the apparatus 82 is shown in a second different configuration. In the first configuration the second section 86 is at a first home position relative to the first section 84. The configuration switch 40 is OFF. Thus, the apparatus 82 is powered down (turned OFF). In this example embodiment the housing of the first section 84 has a slot 90 which the second section 86 is located in. The second section 86 has a projection 92 which extends out of the slot and may be used by a person to push the second section 86 between the first and second configurations. In the first home configuration the second section 86 is located on two or three adjacent sides of the apparatus 82, but substantially flush with the sides of the first section 84 at the slot except for the projection 92.

The user pushes forward on the projection 92 as indicated by arrow 93 to move the second section 86 from its first configuration to its second configuration. In the second different configuration the second section 86 is located at a second outward position relative to the first home position and the first section 84. Portion 88 is outwardly located beyond the slot and beyond the edge of an end of the first section at the slot. The user may use the projection 92 to accomplish this movement of the second section 86 relative to the first section 84. Movement of the two sections 84, 86 causes the configuration switch 40 to be actuated to turn the electronics inside the apparatus ON. Similar to the first example embodiment described above, the switch 40 may sense movement of the body part or movable element 86 from its home position (FIG. 17) towards its second position such as at the second configuration (FIG. 18). This causes the electronics of the apparatus 82 to power-up (turn ON). A wireless connection may be automatically established between the apparatus 82 and the device 14. The apparatus may also send a signal to the device 14 to answer a telephone call. In an alternate embodiment the device 14 could be programmed to automatically answer a telephone call when the link 12 is established without the need for the apparatus to send an off-hook signal.

The user pushes rearward on the projection 92 as indicated by arrow 95 to move the second section 86 from its second configuration back to its first configuration. When the user re-configures the apparatus 82 back to its first configuration, this may actuate or turn OFF the switch 40 again. This may cause the apparatus 82 to power down (turn OFF) and perhaps send a signal to the device 14 to end a telephone call.

Again, similar to the first example embodiment, the change in configuration of the apparatus 82 is used to turn the apparatus 82 ON and OFF. The configuration is easily detectable by the user by sight or touch (if still on the person's ear). By using a relatively large apparatus housing/body part movement to actuate the configuration switch 40, there is no need for the user to deal with a small ON/OFF switch.

Referring also to FIGS. 19-20, another example embodiment is shown. In this embodiment the headset 102 has a first section 104 and a second section 106. The connection of the second section 106 to the first section 104 comprises a longitudinally slidable connection. The first section 104 in this example also has a portion 32 which is sized and shaped to be inserted in an ear canal of a person's ear. The speaker 22 is located in this portion 32. The portion 32 supportably mounts the apparatus 102 on the person's ear. At least some of the electronics 18 could located in the second section 106. Thus, besides a movable mechanical connection between the first and second sections, there could also be an electrical connection between the first and second sections.

FIG. 19 shows the apparatus 102 in its first home configuration. In FIG. 20 the apparatus 102 is shown in a second different configuration. In the first configuration the second section 106 is at a first home position relative to the first section 104. The configuration switch 40 is OFF. Thus, the apparatus 102 is powered down (turned OFF). In this example embodiment the housing of the first section 104 has a slot 108 which the second section 106 is located in. The second section 106 has a projection 110 which extends out of the slot and may be used by a person to push the second section 106 between the first and second configurations. The second section 106 is located on only one side of the apparatus 102. In the first configuration the second section 106 is located at a first home position relative to the portion 32 of the first section 84.

In the second different configuration the second section 106 is located at a second outward position relative to the first home position and the portion 32 of the first section 104. The user may use the projection 110 to accomplish this movement of the second section 106 relative to the first section 104. Movement of the two sections 104, 106 causes the configuration switch 40 to be actuated to turn the electronics inside the apparatus ON. Similar to the first example embodiment described above, the switch 40 can sense movement of the body part or movable element 106 from its home position (FIG. 19) towards its second position; the second configuration (FIG. 20). This causes the electronics of the apparatus 102 to power-up (turn ON). A wireless connection is automatically established between the apparatus 102 and the device 14. The apparatus may also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 102 from its second configuration back to its first configuration, this may actuate or turn OFF the switch 40 again. This may cause the apparatus 102 to power down (turn OFF) and perhaps send a signal to the device 14 to end a telephone call.

Again, similar to the example embodiments described above, the change in configuration of the apparatus 102 is used to turn the apparatus 102 ON and OFF. The configuration is easily detectable by the user by sight or touch (if still on the person's ear). By using a relatively large body part movement to actuate the configuration switch 40, there is no need for the user to deal with a small ON/OFF switch.

The example embodiment shown in FIGS. 19-20 also includes a light signaling section 112. The lights may be illuminated to indicate that the apparatus 102 is on, or that the apparatus 102 is paired to the device 14.

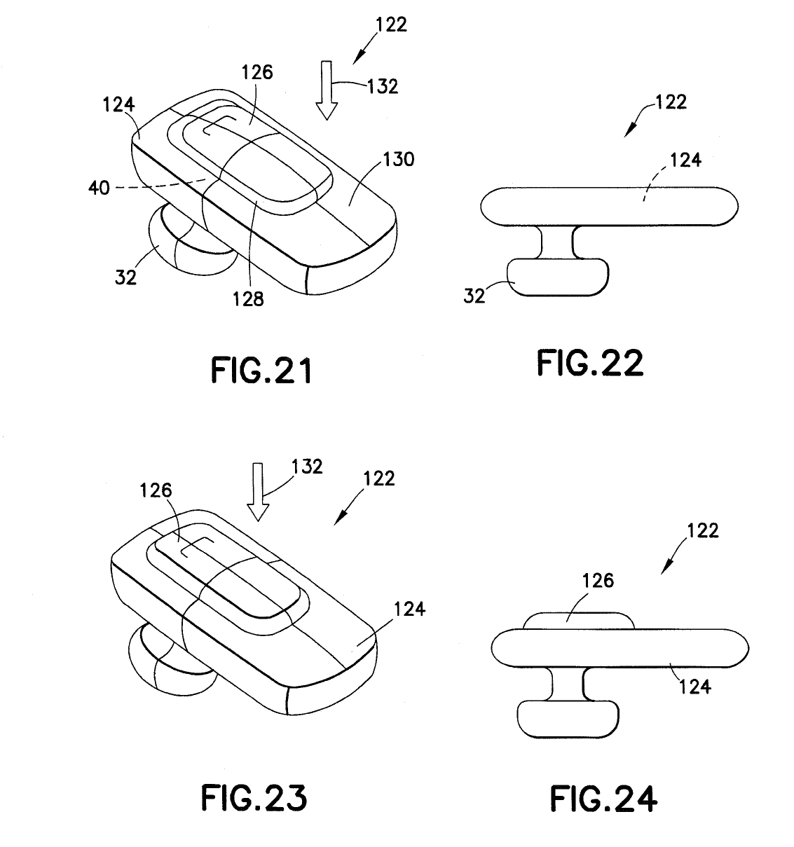

Referring also to FIGS. 21-22, another example embodiment is shown. In this embodiment the headset 122 has a first section 124 and a second section 126. The connection of the second section 126 to the first section 124 comprises a poppet slidable connection. The first section 124 in this example has a portion 32 which is sized and shaped to be inserted in an ear canal of a person's ear. The speaker 22 is located in this portion 32. The portion 32 supportably mounts the apparatus 122 on the person's ear. At least some of the electronics 18 could located in the second section 126. Thus, besides a movable mechanical connection between the first and second sections, there could also be an electrical connection between the first and second sections.

FIGS. 21-22 shows the apparatus 122 in its first home configuration. In FIGS. 23-24 the apparatus 122 is shown in a second different configuration. In the first configuration the second section 126 is at a first home position relative to the first section 124. The configuration switch 40 is OFF. Thus, the apparatus 122 is powered down (turned OFF). In this example embodiment the housing of the first section 124 has a slot 108 in its top side 130 which the second section 126 is located in. The second section 126 has a top side which is substantially flush with the top side of the first section 124 at the slot 128.

The poppet connection of the first and second sections 124, 126 comprises a spring. The second section 126 is lifted from its seating by first applying an axial force. The poppet connection functions similar to a pushbutton ballpoint pen type of tip extension and retraction. A user pushes down on the top of the second section 126 as indicated by arrow 132 and releases the force. The poppet connection releases the second section from its home position and the spring pushes the second section up to an outward extended position (the second different configuration) as shown in FIGS. 23-24.

Comparing FIG. 24 to FIG. 22, in the second different configuration the second section 126 extends to a second outward position relative to the first home position, the portion 32, and the rest of first section 124. Relative movement of the two sections 124, 126 causes the configuration switch 40 to be actuated to turn the electronics inside the apparatus ON. Similar to the first example embodiment described above, the switch 40 may sense movement of the body part or movable element 126 from its home position (FIG. 21) towards its second position such as at the second configuration (FIG. 23). This causes the electronics of the apparatus 122 to power-up (turn ON). A wireless connection is automatically established between the apparatus 122 and the device 14. The apparatus may also send a signal to the device 14 to answer a telephone call. In an alternate embodiment the device 14 could be programmed to automatically answer a telephone call when the link 12 is established without the need for the apparatus to send an off-hook signal.

To re-configure the apparatus 122 from the second configuration to the first configuration, the user again pushes the second section 126 inwards as indicated by arrow 132 in FIG. 23. The second section 126 is locked back in its retracted position in the slot 128 at the first configuration. When the user re-configures the apparatus 122 from its second configuration back to its first configuration, this may actuate or turn OFF the switch 40 again. This can cause the apparatus 122 to power down (turn OFF) and perhaps send a signal to the device 14 to end a telephone call.

Again, similar to the example embodiments described above, the change in configuration of the apparatus 122 is used to turn the apparatus 122 ON and OFF. The configuration is easily detectable by the user by sight or touch (if still on the person's ear). By using a relatively large body part movement to actuate the configuration switch 40, there is no need for the user to deal with a small ON/OFF switch.

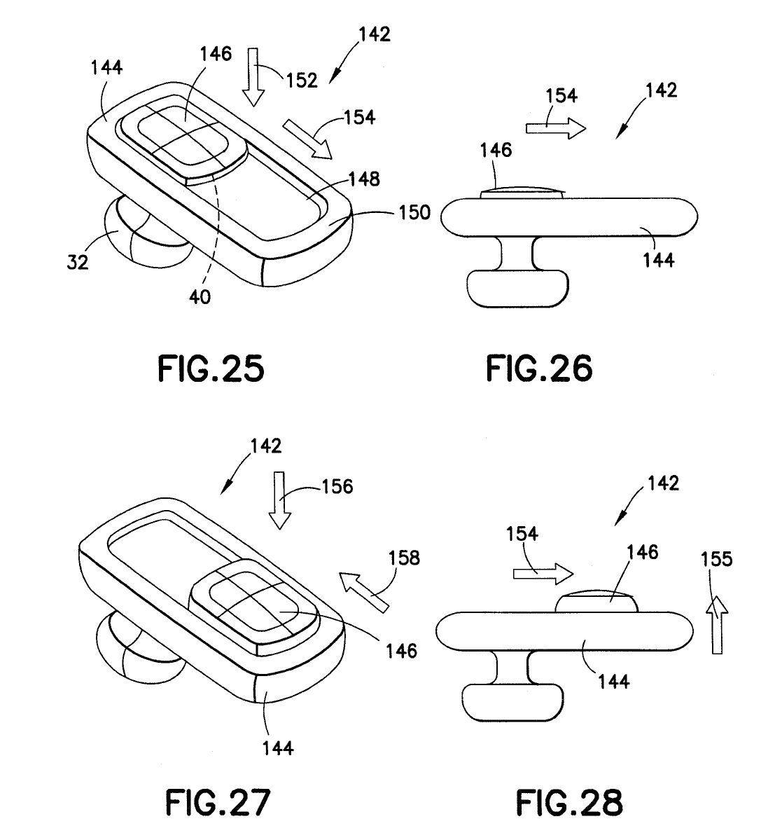

Referring also to FIGS. 25-26, another example embodiment is shown. In this embodiment the headset 142 has a first section 144 and a second section 146. The connection of the second section 146 to the first section 144 comprises a hybrid longitudinal sliding connection and a pop-up connection. The first section 144 in this example has a portion 32 which is sized and shaped to be inserted in an ear canal of a person's ear. The speaker 22 is located in this portion 32. The portion 32 supportably mounts the apparatus 142 on the person's ear. At least some of the electronics 18 could located in the second section 146. Thus, besides a movable mechanical connection between the first and second sections, there could also be an electrical connection between the first and second sections.

FIGS. 25-26 show the apparatus 142 in its first home configuration. In FIGS. 27-28 the apparatus 142 is shown in a second different configuration. In the first configuration the second section 146 is at a first home position relative to the first section 144. The configuration switch 40 is OFF. Thus, the apparatus 142 is powered down (turned OFF). In this example embodiment the housing of the first section 144 has a slot 148 in its top side 150 which the second section 146 is located in. The second section 146 has a top side which extends above the top side 150 of the first section 144 at the slot 128 in the home position.

The connection of the first and second sections 144, 146 comprises a spring and mechanical stops between the two sections 144, 146 to locate the second section 146 at different heights relative to the top surface 150 of the first section 144. In order to move the second section 146 from its first position to its second position, a user pushes down on the top surface of the second section 146 as indicated by arrow 152. The user then slides the second section 146 in the slot 148 as indicated by arrow 154. When the second section 146 reaches the end of the slot 148, the user releases the force 152 and the spring pushes the second section 146 to a second higher outer position as indicated by FIGS. 27-28 (as indicated by arrow 155 in FIG. 28) versus the first configuration shown in FIG. 26.

In the second different configuration (FIGS. 27-28) the second section 146 extends to a second outward position relative to the first home position, the portion 32, and the rest of first section 144. Relative movement of the two sections 144, 146 causes the configuration switch 40 to be actuated to turn the electronics inside the apparatus ON. Similar to the first example embodiment described above, the switch 40 may sense movement of the body part or movable element 146 from its home position (FIGS. 25-26) towards its second position; the second configuration (FIGS. 27-28). This causes the electronics of the apparatus 142 to power-up (turn ON). When the switch 40 is turned ON a wireless connection may be automatically established between the apparatus 142 and the device 14. The apparatus can also send a signal to the device 14 to answer a telephone call. In an alternate embodiment the device 14 could be programmed to automatically answer a telephone call when the link 12 is established without the need for the apparatus to send an off-hook signal.

To re-configure the apparatus 142 from the second configuration back to the first configuration, the user again pushes the second section 146 inwards as indicated by arrow 156 in FIG. 27. The second section 146 is then able to be slid as indicated by arrow 158 back to the other end of the slot 148 and released. The spring biases the second section 146 outward to a locked position, but at the lesser height outer location of the first configuration. When the user re-configures the apparatus 142 from its second configuration back to its first configuration, this can actuate or turn OFF the switch 40 again. This can cause the apparatus 142 to power down (turn OFF) and perhaps send a signal to the device 14 to end a telephone call.

Again, similar to the example embodiments described above, the change in configuration of the apparatus 142 is used to turn the apparatus 142 ON and OFF. The configuration is easily detectable by the user by sight or touch (if still on the person's ear). By using a relatively large body part movement to actuate the configuration switch 40, there is no need for the user to deal with a small ON/OFF switch.

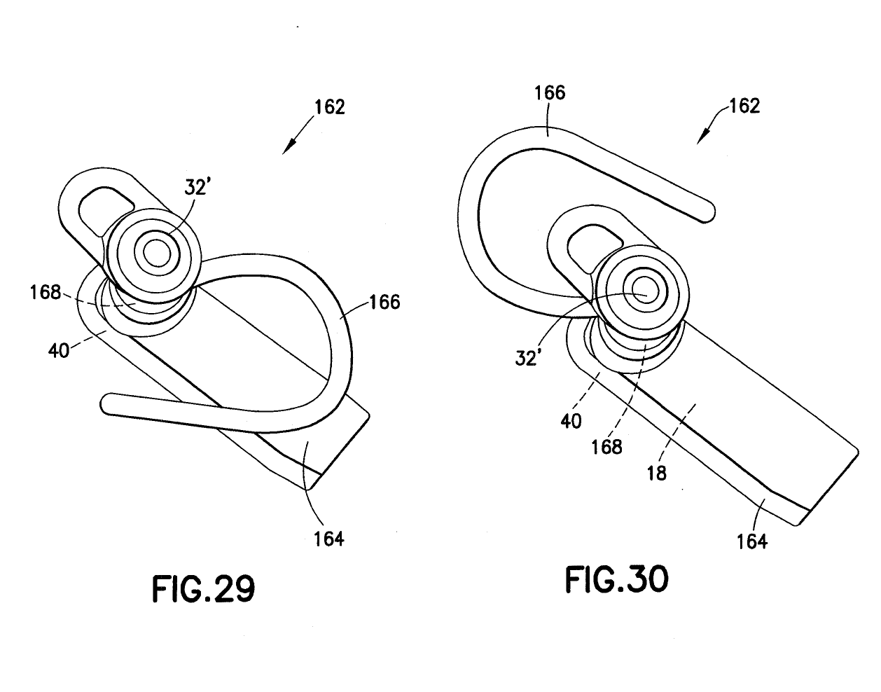

Referring also to FIGS. 29-30, another example embodiment is shown. In this embodiment the headset 162 has a first section 164 and a second section 166. The connection of the second section 166 to the first section 164 comprises a rotatable connection. The second section 166 is a hook shape for use as an attachment on the back and top of the pinna of the user's ear proximate the rest of the user's head. The second section 166 could comprise at least some the electronics or electrical components 18, such as the antenna for example or at least part of the configuration switch 40. The first section 164 in this example has a portion 32′ which is sized and shaped to be inserted in an ear canal of a person's ear. The speaker 22 is located in this portion 32′. The portion 32′ supportably mounts the apparatus 162 on the person's ear.

FIG. 29 shows the apparatus 162 in its first home configuration. FIG. 30 shows the apparatus 162 in a second different configuration. In the first configuration the second section 166 is at a first home position relative to the first section 164. The configuration switch 40 is OFF. Thus, the apparatus 162 is powered down (turned OFF). The configuration switch 40 is located at the rotatable connection of the second section 166 to the first section 164.

In the second different configuration the second section 166 is located at a second outward position relative to the first home position and the first section 164. Relative movement of the two sections 164, 166 causes the configuration switch 40 to be actuated to turn ON the apparatus 162. The rotational connection 168 of the first and second sections 164, 166 is centered in this embodiment. Similar to the example embodiments described above, the switch 40 can sense movement of the body part or movable element 166 from its home position (FIG. 29) towards its second position; the second configuration (FIG. 30). This causes the electronics 18 of the apparatus 162 to power-up (turn ON). A wireless connection is automatically established between the apparatus 162 and the device 14. The apparatus can also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 162 from its second configuration back to its first configuration, this can actuate or turn OFF the switch 40 again. This can cause the apparatus 162 to power down (turn OFF) and perhaps send a signal to the device 14 to end a telephone call. Again, similar to the example embodiments described above, the change in configuration of the apparatus can be used to turn the apparatus 162 ON and OFF. The configuration is easily detectable by the user by sight. The apparatus 162 must be in the second configuration to be hung on the user's pinna. By using a relatively large body part movement to actuate the configuration switch 40, there is no need for the user to deal with a small ON/OFF switch. At least some of the electronics can be located in the second section. Thus, besides a movable mechanical connection between the first and second sections, there can also an electrical connection between components in the first and second sections, such as through the same connection 168.

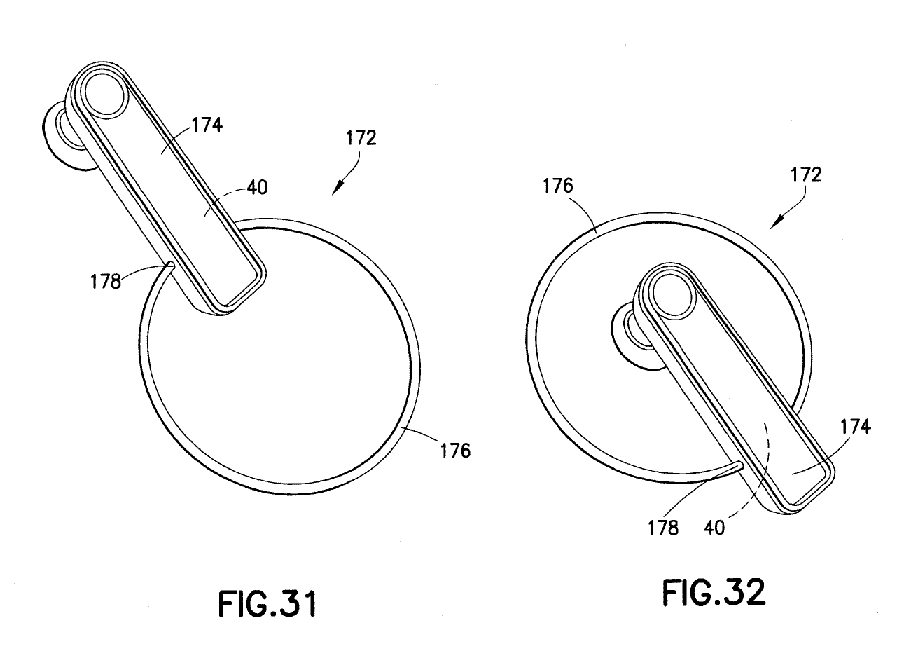

FIGS. 31-32 show another example embodiment. In this example embodiment the headset 172 has a first section 174 and a second section 176. The connection of the second section 176 to the first section 174 comprises a rotatable connection. The second section 176 is a loop shape for use as an attachment on the back and top of the pinna of the user's ear proximate the junction of the pinna with the rest of the user's head. The second section 176 could comprise at least some the electronics or electrical components 18, such as the antenna for example or at least part of the configuration switch 40. The first section 174 in this example also has a portion 32 which is sized and shaped to be inserted in an ear canal of a person's ear. The speaker 22 is located in this portion 32. The portion 32 supportably mounts the apparatus 172 on the person's ear in conjunction with the second section 176.

FIG. 31 shows the apparatus 172 in its first home configuration. FIG. 32 shows the apparatus 172 in a second different configuration. In the first configuration the second section 176 is at a first home position relative to the first section 174. The configuration switch 40 is OFF. Thus, the apparatus 162 is powered down (turned OFF). The configuration switch 40 is located at the rotatable connection of the second section 176 to the first section 174.

In the second different configuration the second section 176 is located at a second outward position relative to the first home position and the first section 174. Relative movement of the two sections 174, 176 causes the configuration switch 40 to be actuated to turn ON the apparatus 172. The rotational connection 178 of the first and second sections 174, 176 is off-centered in this embodiment. Similar to the example embodiments described above, the switch 40 can sense movement of the body part or movable element 176 from its home position (FIG. 31) towards its second position; the second configuration (FIG. 32). This causes the electronics 18 of the apparatus 172 to power-up (turn ON). A wireless connection is automatically established between the apparatus 172 and the device 14. The apparatus can also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 172 from its second configuration back to its first configuration, this can actuate or turn OFF the switch 40 again. This can cause the apparatus 172 to power down (turn OFF) and perhaps send a signal to the device 14 to end a telephone call. Again, similar to the example embodiments described above, the change in configuration of the apparatus can be used to turn the apparatus 172 ON and OFF. The configuration is easily detectable by the user by sight. The apparatus 172 must be in the second configuration to be hung on the user's pinna and be ON. By using a relatively large body part movement to actuate the configuration switch 40, there is no need for the user to deal with a small ON/OFF switch. At least some of the electronics can be located in the second section. Thus, besides a movable mechanical connection between the first and second sections, there can also an electrical connection between components in the first and second sections, such as through the same connection 178.

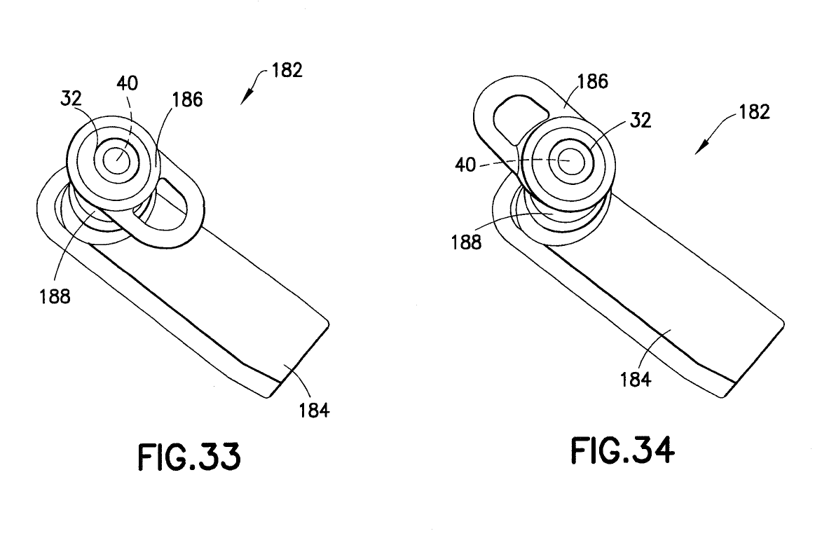

FIGS. 33-34 show another example embodiment. In this example embodiment the headset 182 has a first section 184 and a second section 186. The connection of the second section 186 to the first section 184 comprises a rotatable connection 188. The second section 184 in this example has the portion 32 which is sized and shaped to be inserted in an ear canal of a person's ear. The speaker 22 is located in this portion 32. The portion 32 supportably mounts the apparatus 182 on the person's ear. The first section 184 comprises the rest of the electronics or electrical components 18 and the battery 20. The configuration switch 40 is located at the rotatable connection 188.

FIG. 33 shows the apparatus 182 in its first home configuration. FIG. 34 shows the apparatus 182 in a second different configuration. In the first configuration the second section 186 is at a first home position relative to the first section 184. The configuration switch 40 is OFF. Thus, the apparatus 182 is powered down (turned OFF).

In the second different configuration the second section 186 is located at a second outward position relative to the first home position and the first section 184. Relative movement of the two sections 184, 186 causes the configuration switch 40 to be actuated to turn ON the apparatus 182. The rotational connection 188 of the first and second sections 184, 186 is centered in this embodiment. Similar to the example embodiments described above, the switch 40 can sense movement of the body part or movable element 186 from its home position (FIG. 33) towards its second position; the second configuration (FIG. 34). This causes the electronics 18 of the apparatus 182 to power-up (turn ON). A wireless connection is automatically established between the apparatus 182 and the device 14. The apparatus can also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 182 from its second configuration back to its first configuration, this can actuate or turn OFF the switch 40 again. This can cause the apparatus 182 to power down (turn OFF) and perhaps send a signal to the device 14 to end a telephone call. Again, similar to the example embodiments described above, the change in configuration of the apparatus can be used to turn the apparatus 182 ON and OFF. The configuration is easily detectable by the user by sight. By using a relatively large body part movement to actuate the configuration switch 40, there is no need for the user to deal with a small ON/OFF switch. At least some of the electronics can be located in the second section. Thus, besides a movable mechanical connection between the first and second sections, there can also an electrical connection between components in the first and second sections, such as through the same connection 188.

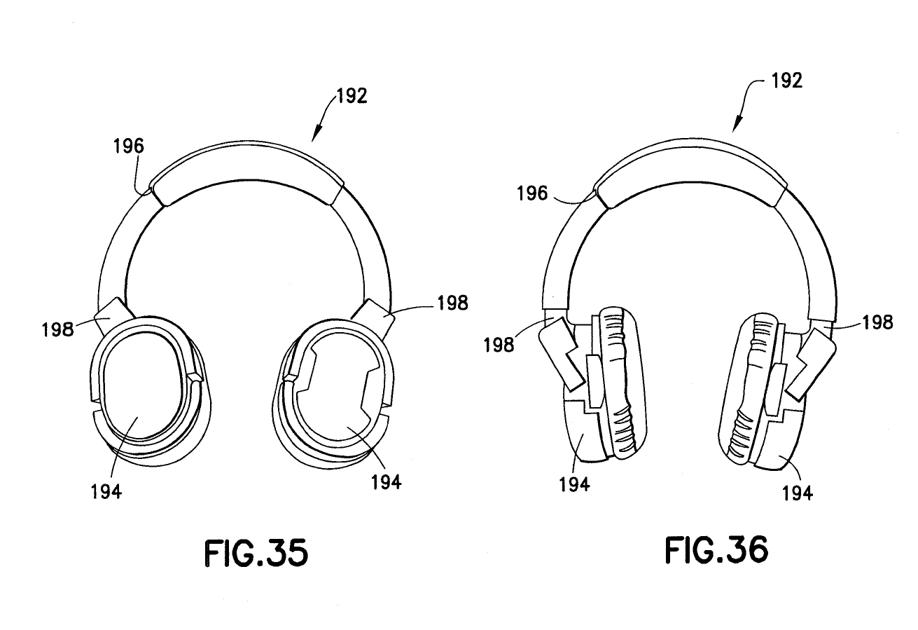

FIGS. 35-36 show a another example embodiment. In this example embodiment the headset 192 has two first sections 194 and a second section 196. The connections of the second sections 196 to the first section 194 comprises rotatable connections 198. The first sections 194 are earmuff type sections configured to mount over an entire ear. The second section 196 is a headband or neckband which has opposite ends connected to the first sections 194 at the rotatable connections 198. The speakers 22 are located in the earmuff shaped first sections 194. The second section 196 may comprise a portion of the electronics, such as a portion of the configuration switch 40. The first sections 194 can comprise the rest of the electronics or electrical components 18 and the battery 20. The configuration switch 40 is located at one or both of the rotatable connections 198.

FIG. 35 shows the apparatus 192 in its first home configuration. FIG. 36 shows the apparatus 192 in the second different configuration. In the first configuration the first sections 194 are at a first home position relative to the second section 196. The configuration switch 40 is OFF. Thus, the apparatus 192 is powered down (turned OFF).

In the second different configuration the first sections 194 are located at a second outward position relative to the second section 196; flipped outward so the earmuff sections face each other. Relative movement of the two sections 194, 196 causes the configuration switch 40 to be actuated to turn ON the apparatus 192. Similar to the example embodiments described above, the switch 40 can sense movement from the home position (FIG. 35) towards its second position; the second configuration (FIG. 36). This causes the electronics 18 of the apparatus 192 to power-up (turn ON). A wireless connection is automatically established between the apparatus 192 and the device 14. The apparatus may also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 192 from its second configuration back to its first configuration, this can actuate or turn OFF the switch 40 again. This may cause the apparatus 192 to power down (turn OFF) and perhaps send a signal to the device 14 to end a telephone call. Again, similar to the example embodiments described above, the change in configuration of the apparatus may be used to turn the apparatus 192 ON and OFF. The configuration is easily detectable by the user by sight. By using a relatively large body part movement to actuate the configuration switch 40, there is no need for the user to deal with a small ON/OFF switch. At least some of the electronics may be located in the second section. Thus, besides a movable mechanical connection between the first and second sections, there may also be an electrical connection between components in the first and second sections, such as through the same connection 198.

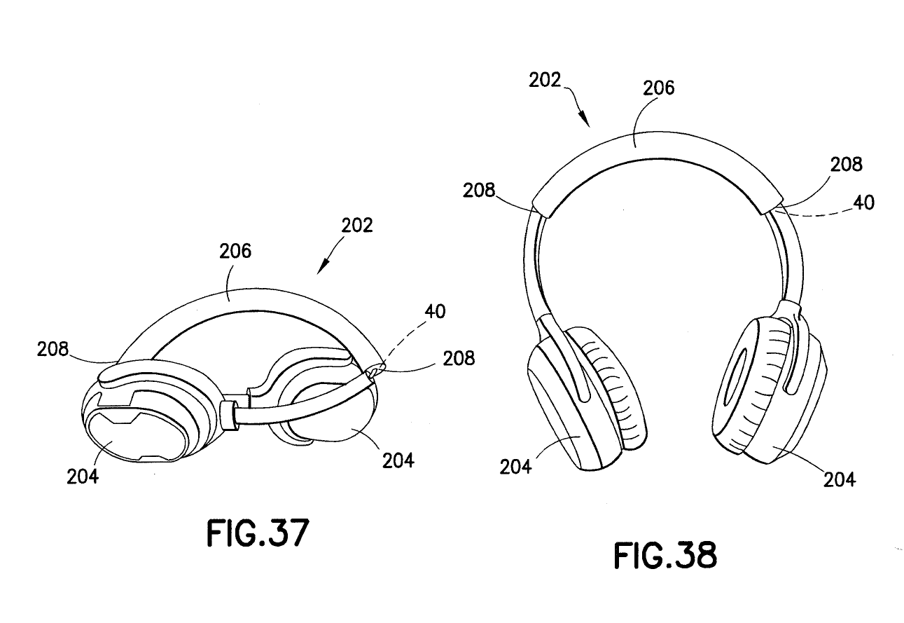

FIGS. 37-38 show another example embodiment with a headset 202 having two first sections 204 and a second section 206. The connections of the second sections 206 to the first section 204 comprise flip-type rotatable connections 208. The first sections 204 are earmuff type sections configured to mount over an entire ear. The second section 206 is a headband or neckband which has opposite ends connected to the first sections 204 at the rotatable connections 208. The speakers 22 are located in the earmuff shaped first sections 204. The second section 206 may comprise a portion of the electronics, such as a portion of the configuration switch 40. The first sections 204 can comprise the rest of the electronics or electrical components 18 and the battery 20. The configuration switch 40 is located at one or both of the rotatable connections 208.

FIG. 37 shows the apparatus 202 in its first home configuration. FIG. 38 shows the apparatus 202 in the second different configuration. In the first configuration the first sections 204 are at a first home position relative to the second section 206. The configuration switch 40 is OFF. Thus, the apparatus 202 is powered down (turned OFF).

In the second different configuration the first sections 204 are located at a second outward position relative to the second section 206; flipped outward so the earmuff sections face each other. Relative movement of the two sections 204, 206 causes the configuration switch 40 to be actuated to turn ON the apparatus 202. Similar to the example embodiments described above, the switch 40 can sense movement from the home position (FIG. 37) towards its second position; the second configuration (FIG. 38). This causes the electronics 18 of the apparatus 202 to power-up (turn ON). A wireless connection is automatically established between the apparatus 202 and the device 14. The apparatus may also send a signal to the device 14 to answer a telephone call. In an alternate embodiment the device 14 could be programmed to automatically answer a telephone call when the link 12 is established without the need for the apparatus to send an off-hook signal.

When the user subsequently re-configures the apparatus 202 from its second configuration back to its first configuration, this can actuate or turn OFF the switch 40 again. This may cause the apparatus 202 to power down (turn OFF) and perhaps send a signal to the device 14 to end a telephone call. Again, similar to the example embodiments described above, the change in configuration of the apparatus may be used to turn the apparatus 202 ON and OFF. The configuration is easily detectable by the user by sight. By using a relatively large body part movement to actuate the configuration switch 40, there is no need for the user to deal with a small ON/OFF switch. At least some of the electronics may be located in the second section. Thus, besides a movable mechanical connection between the first and second sections, there may also be an electrical connection between components in the first and second sections, such as through the same connection 208.

For a good user experience actions such as powering on, connecting to a paired device, and accepting a call are easy to carry out can be advantageous. With embodiments of the invention an implementation of a ready concept can be provided for headphone products. With this concept a single action from the user can cause a headset device to power up, connect to a device, and accept a possible call or other audio stream. This sequence of events can be triggered by operating a movable element comprised in the headset. A novel feature is a movable element designed for actuating a ready function is an user-friendly way.

An example embodiment may comprise an apparatus including a first section which is sized and shaped to be supportably mounted on a person's ear, where the first section comprises a speaker; a second section movably connected to the first section between a first home position and a second outward position relative to the first home position and the first section; and a switch which is configured to be automatically actuated when the second section is moved relative to the first section between the first home position and the second outward position, where the switch is OFF when the first and second sections are in a first configuration with the second section in the first home position, and where the switch is ON when the first and second sections are in a second different configuration with the second section in the second outward position.

The first section may comprise an ear piece canal portion which is sized and shaped to be inserted in an ear canal of the person's ear. The second section may be longitudinally slidable on the first section. The second section may be located on portions of at least two sides of the first section. The first section may comprise a user depressible send/end key which is covered by the second section when the second section is in the first home position, and where the send/end key is not covered by the second section when the second section is in the second outward position. The second section may be configured to depress the send/end key when the second section is moved from the second outward position to the first home position. The second section may have a finger contact section extending from a first side of the first section, and an end which extends past an end of the first section when the second section is in the second outward position. The second section may have a finger contact section extending from a first side of the first section, and an indicator light on a second side of the first section. The second section may comprise a poppet button which is configured to be pushed in relative to the first section in order to pop up on the first section to the second outward position. The first and second sections may be configured and be connected to each other such that the second section longitudinally slides on the first section and then subsequently pops up on the first section when the second section is moved to the second outward position. The second section may be rotatably mounted on the first section. The second section may comprise an ear pinna section configured to wrap around a portion of a pinna of the person's ear. The second section may comprise an ear piece canal portion which is sized and shaped to be inserted in an ear canal of the person's ear. The second section can comprise a headband or neckband connecting two earpiece parts at opposite respective ends of the headband or neckband, where one of the earpieces is the first section.

Another example embodiment may comprise an apparatus including a housing including a first section and a second section movably connected to the first section, where the first or second sections are configured to be supportably mounted on a person's ear, and where the first and second sections are configured to move relative to each other between a first configuration and a second different configuration; electronics in the first section comprising a speaker, a wireless transmitter and a wireless receiver; and a configuration switch connected to the electronics where, when the first and second sections are reconfigured from the first configuration to the second different configuration, the configuration switch turns the apparatus ON and has the electronics send a wireless signal.

Another example may comprise a method including moving a movable element relative to a first section of a wireless headset, where the first section is sized and shaped to be supportably mounted on a person's ear, where the first section comprises a speaker, and where the movable element is moved between a first home position and a second outward position relative to the first home position and the first section; and automatically actuating a switch based upon movement of the movable element between the first home position and the second outward position, where the switch is OFF when the first section and the movable element are in a first configuration with the movable element in the first home position, and where the switch is ON when the first section and the movable element are in a second different configuration with the movable element in the second outward position.

The step of moving the movable element relative to the first section may comprise longitudinally sliding the movable element on the first section. The step of moving the movable element relative to the first section may comprise rotating the movable element on the first section. The step of moving the movable element relative to the first section to turn the switch ON may be configured to turn ON the wireless headset and send a wireless signal to a telephone apparatus to answer an incoming telephone call. The step of moving the movable element relative to the first section to turn the switch OFF may be configured to send a wireless signal to a telephone apparatus to end a telephone call and turn OFF the wireless headset.

Another example may comprise a method including connecting a movable element to a first section of a wireless headset device, where the movable element is configured to move on the first section between a first home position and a second outward position relative to the first home position; and connecting a switch to the first section such that the switch is automatically actuated when the movable element is moved between the first and second positions, where the switch is OFF when the first section and the movable element are in a first configuration with the movable element in the first home position, and where the switch is ON when the first section and the movable element are in a second different configuration with the movable element in the second outward position.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising:
a first section which is sized and shaped to be supportably mounted on a person's ear, where the first section comprises a speaker;
a second section movably connected to the first section between a first home position and a second outward position relative to the first home position and the first section; and
a switch which is configured to be automatically actuated when the second section is moved relative to the first section between the first home position and the second outward position, where the switch is OFF when the first and second sections are in a first configuration with the second section in the first home position, and where the switch is ON when the first and second sections are in a second different configuration with the second section in the second outward position.

2. An apparatus as in claim 1 where the first section comprises an ear piece canal portion which is sized and shaped to be inserted in an ear canal of the person's ear.

3. An apparatus as in claim 1 where the second section is longitudinally slidable on the first section.

4. An apparatus as in claim 1 where the second section is located on portions of at least two sides of the first section.

5. An apparatus as in claim 1 where the first section comprises a user depressible send/end key which is covered by the second section when the second section is in the first home position, and where the send/end key is not covered by the second section when the second section is in the second outward position.

6. An apparatus as in claim 1 where the second section is configured to depress the send/end key when the second section is moved from the second outward position to the first home position.

7. An apparatus as in claim 1 where the second section has a finger contact section extending from a first side of the first section, and an end which extends past an end of the first section when the second section is in the second outward position.

8. An apparatus as in claim 1 where the second section has a finger contact section extending from a first side of the first section, and an indicator light on a second side of the first section.

9. An apparatus as in claim 1 where the second section comprises a poppet button which is configured to be pushed in relative to the first section in order to pop up on the first section to the second outward position.

10. An apparatus as in claim 1 where the first and second sections are configured and is connected to each other such that the second section longitudinally slides on the first section and then subsequently pops up on the first section when the second section is moved to the second outward position.

11. An apparatus as in claim 1 where the second section is rotatably mounted on the first section.

12. An apparatus as in claim 11 where the second section comprises an ear pinna section configured to wrap around a portion of a pinna of the person's ear.

13. An apparatus as in claim 11 where the second section comprises an ear piece canal portion which is sized and shaped to be inserted in an ear canal of the person's ear.

14. An apparatus as in claim 11 where the second section comprises a headband or neckband connecting two earpiece parts at opposite respective ends of the headband or neckband, where one of the earpieces is the first section.

15. An apparatus as in claim 1 comprising means for turning the apparatus ON and OFF based upon a configuration of the first and second sections relative to each other, means for automatically establishing a wireless link with a telephone device when the means for turning the apparatus ON and OFF turns the apparatus ON, and means for signaling the telephone device to answer an incoming call with the apparatus is turned ON.

16. An apparatus comprising:
a housing including a first section and a second section movably connected to the first section, where the first or second sections are configured to be supportably mounted on a person's ear, and where the first and second sections are configured to move relative to each other between a first configuration and a second different configuration;
electronics in the first section comprising a speaker, a wireless transmitter and a wireless receiver; and
a configuration switch connected to the electronics where, when the first and second sections are reconfigured from the first configuration to the second different configuration, the configuration switch turns the apparatus ON and has the electronics send a wireless signal.

17. A method comprising:
moving a movable element relative to a first section of a wireless headset, where the first section is sized and shaped to be supportably mounted on a person's ear, where the first section comprises a speaker, and where the movable element is moved between a first home position and a second outward position relative to the first home position and the first section; and
automatically actuating a switch based upon movement of the movable element between the first home position and the second outward position, where the switch is OFF when the first section and the movable element are in a first configuration with the movable element in the first home position, and where the switch is ON when the first section and the movable element are in a second different configuration with the movable element in the second outward position.

18. A method as in claim 17 where moving the movable element relative to the first section comprises longitudinally sliding the movable element on the first section.

19. A method as in claim 17 where moving the movable element relative to the first section comprises rotating the movable element on the first section.

20. A method as in claim 17 where moving the movable element relative to the first section to turn the switch ON is configured to turn ON the wireless headset and send a wireless signal to a telephone apparatus to answer an incoming telephone call.

21. A method as in claim 17 where moving the movable element relative to the first section to turn the switch OFF is configured to send a wireless signal to a telephone apparatus to end a telephone call and turn OFF the wireless headset.

22. A method comprising:
connecting a movable element to a first section of a wireless headset device, where the movable element is configured to move on the first section between a first home position and a second outward position relative to the first home position; and
connecting a switch to the first section such that the switch is automatically actuated when the movable element is moved between the first and second positions, where the switch is OFF when the first section and the movable element are in a first configuration with the movable element in the first home position, and where the switch is ON when the first section and the movable element are in a second different configuration with the movable element in the second outward position.
